(19) United States
(12) Patent Application Publication
(10) Pub. No.: US 2006/0014527 A1
(43) Pub. Date: Jan. 19, 2006

(54) Apparatus and method for transmitting voice message in mobile communication terminal

(75) Inventor: Jang Wook Oh, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Pantech Co., Ltd.

(21) Appl. No.: 11/123,905

(22) Filed: May 6, 2005

(30) Foreign Application Priority Data
Jul. 15, 2004 (KR) 10-2004-0055226

(51) Int. Cl. H04M 11/10

(52) U.S. Cl. 455/413; 455/412.1

(57) ABSTRACT

The present invention relates to an apparatus and method for transmitting voice message in mobile communication terminal which may automatically transmit voice message of a caller and receive voice message of a receiver in response to the voice message of the caller. There is provided an apparatus for transmitting voice message in mobile communication terminal comprising: an information input unit for receiving caller's input of information for voice message transmit; an voice message input unit for receiving input of voice message; an information storage unit for storing the information for voice message transmit; an voice message storage unit for storing the voice message and the receiver's voice message received in response to the voice message of the caller; a control unit for controlling registry of the information for voice message transmit, storage of the voice message, and transmit of the voice message; and an voice message output unit for outputting the receiver's voice message.

### CROSS-REFERENCE TO RELATED APPLICATION

The present application is claiming priority of Korean Patent Application No. 10-2004-0055226, filed on Jul. 15, 2004, the content of which is incorporated herein by reference.

### BACKGROUND OF THE INVENTION

1. Field of the Invention

The present invention relates to an apparatus and method for transmitting voice message in mobile communication terminal. More particularly, the present invention relates to an apparatus and method for transmitting voice message in mobile communication terminal which may automatically transmit voice message of a caller and receive voice message of a receiver in response to the voice message of the caller, by attempting a call to the receiver's mobile communication terminal (“called mobile communication terminal”) automatically according to time and number of times previously set in the caller's mobile communication terminal (“caller mobile communication terminal”).

2. Description of the Related Art

Generally, up to now, when a caller wishes to inform a receiver of certain facts with his/her mobile communication terminal (“caller mobile communication terminal”) at a particular time, the caller makes a telephone call at that time by using an alarm of other apparatus or by simply relying on their memory. In other words, the caller needs to remember to make a telephone call at the particular time by using an alarm clock, memo and memory etc.

Accordingly, there is a problem in that whether the caller can give the receiver instructions or inform the receiver of certain facts is simply determined depending on whether the caller can remember or not.

Moreover, if the receiver does not answer the phone, there is another inconvenience that the caller needs to make a telephone call again.

### SUMMARY OF THE INVENTION

To solve the above problems, there is provided an apparatus and method for transmitting voice message in mobile communication terminal which may automatically transmit voice message of a caller and receive voice message of a receiver in response to the voice message of the caller, by attempting a call to a called mobile communication terminal automatically according to time and number of times previously set in a caller mobile communication terminal.

There is provided an apparatus and method for transmitting voice message in mobile communication terminal comprising: an information input unit for receiving caller's input of information for voice message transmit; an voice message input unit for receiving from the caller input of voice message to be transmitted to a receiver's mobile communication terminal; an information storage unit for storing the information for voice message transmit; an voice message storage unit for storing the voice message to be transmitted to the receiver's mobile communication terminal and the receiver's voice message received in response to the voice message of the caller; a control unit for controlling registry of the information for voice message transmit, storage of the voice message, and transmit of the voice message; and an voice message output unit for outputting the receiver's voice message received in response to the voice message of the caller.

Preferably, the apparatus may further comprise a guidance message storage unit for storing guidance message to be transmitted to the receiver's mobile communication terminal.

Preferably, the information for voice message transmit may comprise: called mobile communication terminal number information, call attempt time information, call attempt number of times information and information on whether to respond to the voice message from the caller, the called mobile communication terminal number information indicating telephone number of the called mobile communication terminal which will receive the voice message, the call attempt time information indicating date and time at which call will be attempted to transmit the voice message, the call attempt number of times information indicating time period which call will be attempted and time at which the call attempt is stop, the information on whether to respond to the voice message from the caller indicating whether a response of the receiver is necessary.

Preferably, the guidance message may comprise: a regeneration guidance message informing the receiver of regeneration of the voice message of the caller; and a response guidance message informing the receiver of whether it is necessary for the receiver to transmit voice message in response to the voice message of the caller.

In order to achieve at least the above objects, there is provided a method of transmitting voice message in mobile communication terminal comprising: receiving input of call attempt time information, information on date and time at which call is attempted, and storing the call attempt time information; receiving input of call attempt number of times information, information on time period which call will be attempted and time at which the call attempt is stop, and storing the call attempt number of times information; receiving input of called mobile communication terminal number information indicating telephone number of the called mobile communication terminal which will receive the voice message of the caller; receiving from the caller input of voice message to be transmitted to the receiver's mobile communication terminal and storing the voice message; receiving information on whether to respond to the voice message of the caller indicating whether a response of the receiver is necessary and storing the information on whether to respond; checking the call attempt time information, the call attempt number of times information, called mobile communication terminal number information and the information on whether to respond to the voice message of the caller; attempting a call between the caller's mobile communication terminal and the receiver's mobile communication terminal with reference to the called mobile communication terminal number information, if it is time to attempt a call to transmit the voice message of the caller according to the call attempt time information; and if the call attempt is succeeded, transmitting the voice message of the caller to the receiver's mobile communication terminal.

Preferably, the method may further comprise: transmitting a regeneration guidance message to the called mobile communication terminal, if the call attempt is succeeded.

Preferably, the method may further comprise: attempting a call to the called mobile communication terminal according to the call attempt number of times information, if the call attempt is failed.

Preferably, the method may further comprise: determining whether the receiver needs to respond to the voice message of the caller by checking the information on whether to respond to the voice message; completing the call connection, if the receiver does not need to respond to the voice message of the caller; receiving the receiver's voice message from the receiver's mobile communication terminal and storing the receiver's voice message in the caller's mobile communication terminal, if the receiver needs to respond to the voice message of the caller; and outputting the receiver's voice message to the caller, if output of the receiver's voice message is asked by the caller.

Preferably, the method may further comprise: transmitting a response guidance message to the receiver's mobile communication terminal, if the receiver needs to respond to the voice message of the caller.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates configuration of an apparatus for transmitting voice message in mobile communication terminal according to a preferred embodiment of the present invention;

FIG. 2 is a flow chart for illustrating a method for transmitting voice message in mobile communication terminal according to a preferred embodiment of the present invention; and

FIG. 3 is a flow chart for illustrating processes of storing information and voice message.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

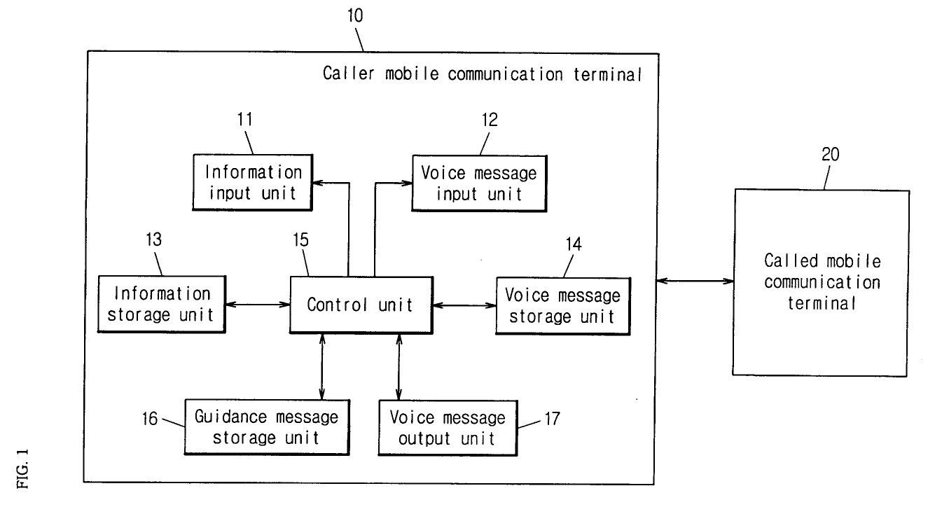

Hereinafter, configuration of an apparatus for transmitting voice message in mobile communication terminal according to the preferred embodiment of the present invention will be explained with reference to the FIG. 1.

The apparatus for transmitting voice message in mobile communication terminal according to the preferred embodiment of the present invention comprises an information input unit 11, an voice message input unit 12, an information storage unit 13, an voice message storage unit 14, a control unit 15, a guidance message storage unit 16 and an voice message output unit 17.

The information input unit 11 receives input of information for voice message transmit from the caller.

The information for voice message transmit comprises: called mobile communication terminal number information, call attempt time information, call attempt number of times information and information on whether to respond to the voice message of the caller. The called mobile communication terminal number information indicates telephone number of the called mobile communication terminal which will receive the voice message of the caller. The call attempt time information indicates date and time at which call will be attempted to transmit the voice message. The call attempt number of times information indicates time period which call will be attempted and time at which the call attempt is stop. The information on whether to respond to the voice message of the caller indicates whether a response of the receiver is necessary.

The voice message input unit 12 receives from the caller input of voice message to be transmitted to the called mobile communication terminal.

The information storage unit 13 stores the information for voice message transmit.

The voice message storage unit 14 stores the voice message of the caller and voice message of the receiver, which is a response to the voice message of the caller.

The control unit 15 controls registry of the information for voice message transmit, storage of the voice message, transmit of the voice message and etc.

The guidance message storage unit 16 stores guidance message to be transmitted to the called mobile communication terminal when the voice message is transmitted to the called mobile communication terminal. The guidance message comprises a regeneration guidance message that informs the receiver of regeneration of the voice message, and a response guidance message that informs the receiver that the receiver needs to respond to the voice message of the caller.

The voice output unit 17 outputs the voice message received from the called mobile communication terminal.

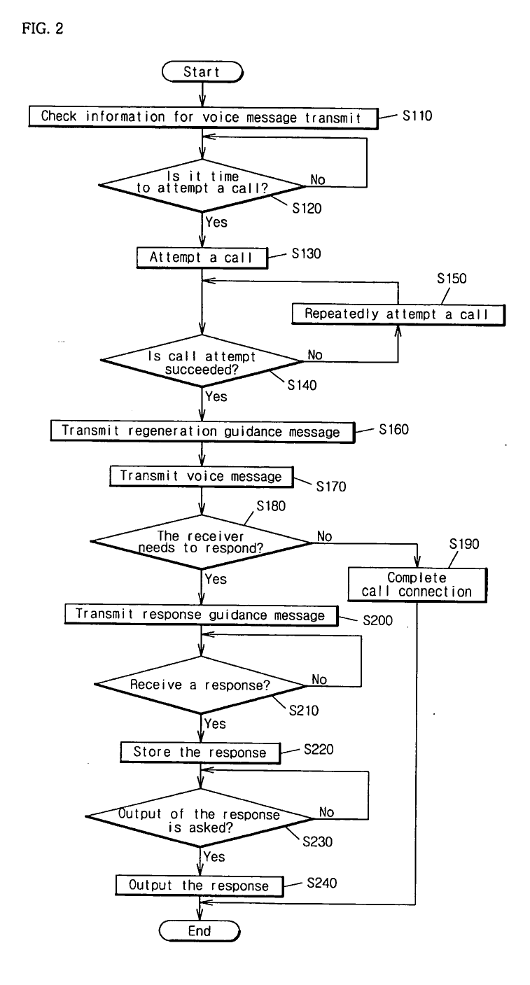

Hereinafter, the method for transmitting voice message in mobile communication terminal according to the preferred embodiment of the present invention will be explained with reference to FIG. 2.

In order to transmit voice message from a caller mobile communication terminal 10 to the called mobile communication terminal 20, the control unit 15 of the caller mobile communication terminal 10 checks previously stored information for voice message transmit such as called mobile communication terminal number information, call attempt time information, call attempt number of times information and information on whether to respond to the voice message of the caller by retrieving the information for voice message transmit from the information storage unit 13 (S110).

The control unit 15 determines whether it is time to attempt a call to transmit voice message from the caller mobile communication terminal to the called mobile communication terminal, with reference to the call attempt time information (S120).

Upon the determination at the step S120, in a case where it is time to attempt a call according to the call attempt time information, the control unit 15 attempts a call to the called mobile communication terminal with reference to the called mobile communication terminal number information (S130).

And, the control unit 15 determines whether the call attempt is succeeded or not (S140).

Upon the determination at the step S140, in a case where the call attempt is failed, the control unit 15 repeatedly attempts a call to the called mobile communication terminal 20 with reference to the call attempt number information (S150).

On the other hand, if the call attempt is succeeded upon the determination at the step S140, the control unit 15 reads the regeneration guidance message stored in the guidance message storage unit 16 and transmits the regeneration guidance message to the called mobile communication terminal (S160). Then, the receiver listens to the regeneration guidance message from the called mobile communication terminal 20. For instance the regeneration guidance message can be “Voice message from the caller will be regenerated after the beep.”

And, the control unit 15 reads the voice message from the voice message storage unit 14 and transmits the voice message from the caller mobile communication terminal to the called mobile communication terminal (S170). Then, the receiver listens to the voice message of the caller from the called mobile communication terminal.

The control unit 15 determines whether the receiver needs to respond to the voice message of the caller with reference to the information on whether to respond to the voice message from the caller (S180).

If the receiver does not need to respond to the voice message upon the determination at the step S180, the control unit 15 completes the call connection (S190).

On the other hand, if the receiver needs to respond to the voice message of the caller upon the determination at the step S180, the control unit 15 reads the response guidance message stored in the guidance message storage unit 16 and transmits the response guidance message to the called mobile communication terminal 20 (S200). Then, the receiver listens to the response guidance message from the called mobile communication terminal. For instance, the response guidance message can be “Record your response to the caller after the beep.” The receiver inputs voice message of the receiver, a response to the voice message of the caller, into the called mobile communication terminal. And, the voice message of the receiver is transmitted to the caller mobile communication terminal 10.

Then, the control unit 15 receives the voice message of the receiver from the called mobile communication terminal 20 (S210).

The control unit 15 makes the voice message storage unit 14 store the voice message of the receiver (S220).

When the control unit 15 is asked by the caller to output the voice message of the receiver (S230), the control unit 15 makes the voice message output unit 17 output the voice message of the receiver stored in the voice message storage unit 14 (S240). Then, the caller listens to the voice message of the receiver.

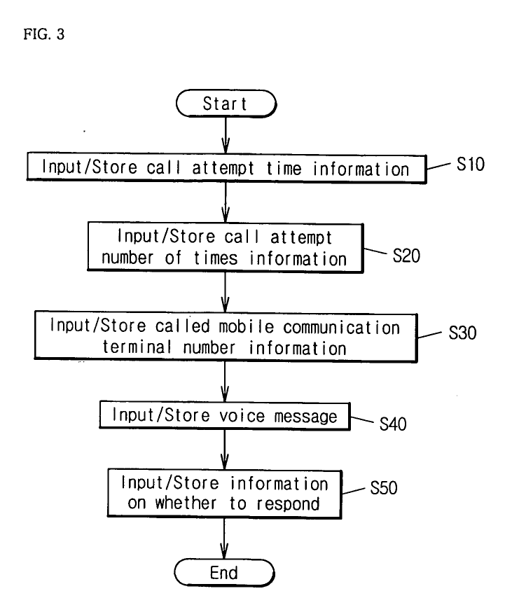

Hereinafter, processes of storing information and voice message in FIG. 2 will be explained with reference to FIG. 3.

First, the caller inputs the information for voice message transmit into the information input unit 11, and voice message to be transmitted into the voice message input unit 12.

Then, the control unit 15 makes the information storage unit 13 store the call attempt time information inputted through the information input unit 11, the call attempt time information indicating date and time at which call will be attempted to transmit the voice message (S10). For example, if the date and time is set to be 4:00 p.m. 29 Jun. 2004, the caller mobile communication terminal 10 will attempt a call to the called mobile communication terminal at that time.

The control unit 15 makes the information storage unit 13 store the call attempt number of times information inputted through the information input unit 11, the call attempt number of times information indicating time period which call will be attempted and time at which the call attempt is stop (S20). For example, if the time period is 10 minutes and the time at which the call attempt is stop is 5:00 p.m. 29 Jun. 2004, it means total call attempt is performed 7 times for 60 minutes.

The control unit 15 makes the information storage unit 13 store the called mobile communication terminal number information inputted through the information input unit 11, the called mobile communication terminal number information indicating telephone number of the called mobile communication terminal which will receive the voice message from the caller mobile communication terminal (S30).

The control unit 15, then, makes the voice message storage unit 14 store the voice message inputted through the voice message input unit 12 (S40).

Then, the control unit 15 makes the information storage unit 13 store the information on whether to respond to the voice message of the caller inputted through the information input unit 11 (S50). In other words, the caller establishes the necessity of the receiver's response through flag when the receiver's response is needed.

As described above, it is made possible for the caller to transmit voice message to the called mobile communication terminal, by attempting a call automatically to the called mobile communication terminal according to the apparatus for transmitting voice message of the present invention.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. An apparatus for transmitting voice message in mobile communication terminal comprising:
an information input unit for receiving caller's input of information for voice message transmit;
an voice message input unit for receiving from the caller input of voice message to be transmitted to a receiver's mobile communication terminal;
an information storage unit for storing the information for voice message transmit;
an voice message storage unit for storing the voice message to be transmitted to the receiver's mobile communication terminal and the receiver's voice message received in response to the voice message of the caller;
a control unit for controlling registry of the information for voice message transmit, storage of the voice message, and transmit of the voice message; and
an voice message output unit for outputting the receiver's voice message received in response to the voice message of the caller.

2. The apparatus according to claim 1, further comprising:
a guidance message storage unit for storing guidance message to be transmitted to the receiver's mobile communication terminal.

3. The apparatus according to claim 1, wherein the information for voice message transmit comprises:
called mobile communication terminal number information, call attempt time information, call attempt number of times information and information on whether to respond to the voice message from the caller, the called mobile communication terminal number information indicating telephone number of the called mobile communication terminal which will receive the voice message, the call attempt time information indicating date and time at which call will be attempted to transmit the voice message, the call attempt number of times information indicating time period which call will be attempted and time at which the call attempt is stop, the information on whether to respond to the voice message from the caller indicating whether a response of the receiver is necessary.

4. The apparatus according to claim 2, wherein the guidance message comprises:
a regeneration guidance message informing the receiver of regeneration of the voice message of the caller; and
a response guidance message informing the receiver of whether it is necessary for the receiver to transmit voice message in response to the voice message of the caller.

5. A method of transmitting voice message in mobile communication terminal comprising:
receiving input of call attempt time information, information on date and time at which call is attempted, and storing the call attempt time information;
receiving input of call attempt number of times information, information on time period which call will be attempted and time at which the call attempt is stop, and storing the call attempt number of times information;
receiving input of called mobile communication terminal number information indicating telephone number of the called mobile communication terminal which will receive the voice message of the caller;
receiving from the caller input of voice message to be transmitted to the receiver's mobile communication terminal and storing the voice message;
receiving information on whether to respond to the voice message of the caller indicating whether a response of the receiver is necessary and storing the information on whether to respond;
checking the call attempt time information, the call attempt number of times information, called mobile communication terminal number information and the information on whether to respond to the voice message of the caller;
attempting a call between the caller's mobile communication terminal and the receiver's mobile communication terminal with reference to the called mobile communication terminal number information, if it is time to attempt a call to transmit the voice message of the caller according to the call attempt time information; and
if the call attempt is succeeded, transmitting the voice message of the caller to the receiver's mobile communication terminal.

6. The method according to claim 5, further comprising:
transmitting a regeneration guidance message to the called mobile communication terminal, if the call attempt is succeeded.

7. The method according to claim 5, further comprising:
attempting a call to the called mobile communication terminal according to the call attempt number of times information, if the call attempt is failed.

8. The method according to claim 5, further comprising:
determining whether the receiver needs to respond to the voice message of the caller by checking the information on whether to respond to the voice message;
completing the call connection, if the receiver does not need to respond to the voice message of the caller;
receiving the receiver's voice message from the receiver's mobile communication terminal and storing the receiver's voice message in the caller's mobile communication terminal, if the receiver needs to respond to the voice message of the caller; and
outputting the receiver's voice message to the caller, if output of the receiver's voice message is asked by the caller.

9. The method according to claim 8, further comprising:
transmitting a response guidance message to the receiver's mobile communication terminal, if the receiver needs to respond to the voice message of the caller.
